(19) United States
(12) Patent Application Publication
(10) Pub. No.: US 2007/0108900 A1
(43) Pub. Date: May 17, 2007

(54) Method and apparatus for the elimination of interference fringes in an OLED device

(76) Inventors: Heather Debra Boek, Corning, NY (US); Ralph A Langensiepen, Corning, NY (US)

Correspondence Address: CORNING INCORPORATED, SP-TI-3-1, CORNING, NY, 14831, US

(21) Appl. No.: 11/598,376

(22) Filed: Nov. 13, 2006

Related U.S. Application Data
(60) Provisional application No. 60/737,132, filed on Nov. 15, 2005.

(51) Int. Cl. H01J 1/62; H01J 63/04

(52) U.S. Cl. 313/506

(57) ABSTRACT

A technique for reducing the appearance of Newton's rings for a light emitting device is disclosed. The light emitting device comprises a scattering layer positioned contiguous with the inner surface of a cover substrate. Scattering the light reduces or eliminates the opportunity for constructive interference and as a result reduces or eliminates Newton's ring formation.

This application claims priority to and the benefit of U.S. Provisional Patent Application No. 60/737,132 filed Nov. 15, 2005.

### BACKGROUND OF THE INVENTION

1. Field of the Invention

The present invention is directed to an Organic Light Emitting Diode (OLED). Specifically, the present invention is directed to a method and apparatus for eliminating Newton's rings in an OLED.

2. Technical Background

The combination of reflected light between two glass surfaces of different curvature separated by an air gap of varying thickness may create a visible interference pattern known as Newton's rings. Similarly, in a glass substrate with two nearly parallel sides, a light ray may enter the glass substrate through a first side and create a first reflection by reflecting off of the first side of the glass substrate. The same light ray may also reflect off of the second side of the glass substrate and create a second reflection. When the first reflection and the second reflection combine in a constructive way (i.e., complimenting and adding to each other or constructive interference) a bright region is created by the constructive interference when viewed from first side of the glass substrate. When the first and second reflections combine in a destructive way (i.e., subtracting from each other or destructive interference) a dark region appears when viewed from first side of the glass substrate. When ambient light is directed to a glass substrate the constructive and destructive interference creates a series of alternating light and dark rings, which are herein referred to collectively as Newton's rings. The rings are contours of equal optical path difference between two reflecting surfaces.

An Organic Light Emitting Diode (OLED) device includes an OLED and a thin transparent electrode material (i.e., active light emitting materials) positioned between two thin glass substrates. A newly developed type of flat panel display technology uses the OLED device to create superior viewing qualities in the display. The active light emitting materials are sensitive to damage by contaminants, including water and oxygen. As a result, the perimeters of the device have to be sealed to maintain a water and oxygen free environment since the active materials are destroyed by part-per-million (ppm) levels of these contaminants. The sealed environment is often referred to as a cell.

If the seal is not hermetic over the intended lifetime of the display, a desiccant is typically placed inside the cell. Commercially available sealant systems do not typically provide hermetic seals that survive the lifetime of the display, and thus require a desiccant. The inclusion of a non-transparent desiccant requires that the light emitted from the OLED is directed through a matrix of electronic drivers and electrodes out of the bottom of the OLED device (i.e., “bottom emission”). A lasting hermetic seal would not require a desiccant and as such the emitted light may be transmitted through a transparent cover substrate (i.e., top emission) to preserve image brightness and clarity. Hermetic sealant solutions such as the use of inorganic frits enable the OLED display to be implemented with top emission OLEDs because a hermetically sealed OLED eliminates the need for a desiccant.

Ambient lighting can create Newton's rings on a cover substrate of an OLED. Visible interference fringes may appear on the cover plate of an OLED due to the constructive/destructive interference of the ambient light reflected from the inner surfaces of the OLED cell. Light reflected at the interface of a low index of refraction medium and a high index of refraction medium, for example, air to an OLED, experiences a 180 degree phase reversal. As a result, the light reflected from the inside surface of a cover substrate may combine with light reflected from the OLED surface, producing interference fringes.

In order to make the devices as thin as possible, the gap between conventional substrates is targeted to be less than 100 microns, with recent targets less than 15 microns. In this gap range, Newton's ring interference patterns form and are visible under ambient lighting if the gap distance is not uniform. Commercial pressures continuously require the production of thinner devices. As the thickness of the air gap decreases, it becomes more difficult to prevent Newton's rings.

Current solutions to the interference fringing problem include the use of no air gap in bottom emission devices, and large air gaps larger than the coherence length of fluorescent lighting, greater than 100 microns. The former suffers from brightness and resolution losses. The latter increases the surface area of the device seal, thereby decreasing the hermeticity and lifetime of the device. Thus, it would advantageous to find an alternate approach to diminishing or eliminating Newton's rings in OLED devices.

### SUMMARY OF THE INVENTION

In accordance with the teachings of the present invention, a scattering layer is deployed in an organic light emitting device to eliminate or mitigate Newton's rings.

In one embodiment, the present invention relates to a light emitting display device that does not exhibit Newton's rings, or displays a substantially reduced Newton's ring pattern. In accordance with the teachings of the present invention, a scattering layer is deployed on the inner surface of a light emitting device cover substrate to reduce the internal reflection of ambient light and mitigate the formation of Newton's rings. The scattering layer eliminates the continuous contours of equal optical path that are visible to the human eye and replaces them with small discontinuous regions of interference that are not detectable under normal viewing conditions.

In one embodiment, the present invention includes a light emitting device comprising a cover substrate capable of receiving light and having a first surface and a second surface oppositely disposed from the first surface, a support substrate, and a light emitting element positioned between the cover substrate and the support substrate, wherein the light emitting element emits light in the direction of a scattering layer positioned between the first substrate and the light emitting element. In accordance with the teachings of the present invention, the scattering layer scatters incoming light thereby mitigating or eliminating the formation of a Newton's ring pattern on the second surface.

In another embodiment of the present invention, a diffuse reflection condition is created in the cover substrate of an OLED device. The diffuse reflection condition produces scattering of the reflection(s) of any light generated by the light emitting element.

In another embodiment a solution is provided to eliminate Newton's rings from top emitting OLED devices by deploying a scattering layer in the top emitting OLED device, while maintaining the brightness and resolution qualities of the device.

In one embodiment, the present invention scatters the internally reflected and transmitted ambient light, disrupting the coherent superposition of the reflected light by virtue of the fact that the scattering randomizes the reflection angles across the OLED device.

In another embodiment, a scattering layer is provided in an OLED by roughening a single surface or both the inner and outer surfaces of an OLED cover substrate.

In one embodiment, specular reflection or glare is eliminated in an OLED by implementing a scattering layer on both surfaces of a cover substrate. For example, in one embodiment, both surfaces of the cover substrate of an OLED may be roughened.

Additional aspects of the invention will be set forth, in part, in the detailed description, figures and claims which follow, and in part will be derived from the detailed description, or can be learned by practice of the aspects invention described below. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain aspects of the instant invention and together with the description, serve to explain, without limitation, the principles of the invention.

FIG. 1 is a schematic diagram illustrating a light emitting device with a scattering, according to one aspect of the present invention.

FIG. 2 is a close up of the scattering layer 50 shown as in FIG. 1.

FIG. 3 is a close up of the scattering layer 50 implemented with transparent particles.

### DETAILED DESCRIPTION OF THE INVENTION

In accordance with the teachings of the present invention, a top emission OLED device is provided with a scattering layer to scatter the light generated by a light emitting element thereby mitigating or eliminating Newton's rings. The scattering layer may be implemented on the inside of a cover surface of an OLED, on the outside of a cover surface of an OLED, or on a combination of the inside surface and the outside surface. In accordance with the teachings of the present invention, the scattering layer is implemented such that the transmission of light through the cover glass is not compromised by the scattering layer. In one embodiment, the surface topography and scattering ability of the scattering layer are characterized, and the scattering layer is implemented with a roughened surface. In addition, various methods of implementing the roughened surface are disclosed. An OLED device implemented in accordance with the teachings of the present invention may be implemented in a variety of applications such as cellular telephones, televisions, etc.

In accordance with the teachings of the present invention a scattering layer is implemented that mitigates all interference fringing effects caused by ambient lighting. In one embodiment, the scattering layer is implemented by controlling the surface roughness to the minimum required for effectiveness while minimizing any transmission loss and resolution loss. As such, the surface roughness of the inner surface of the cover glass of an OLED is defined to create a diffuse reflection condition that eliminates observable interference, without reducing the direct transmission of OLED light and without affecting the image intensity and resolution.

In one embodiment a method of processing a pristine display glass cover plate to provide a degree of surface roughness has been demonstrated to eliminate the creation of visible interference fringing in glass to glass cells with in an air gap that is less than or equal to 60 microns, which mitigates the effectiveness of the Newton's rings while exhibiting minimal effects on transmission.

In accordance with the teachings of the present invention, a scattering layer that removes or mitigates Newton's rings is defined to have the following characteristics: a roughness (RMS) greater than 0.02 microns and less than 0.5 microns, measured over an area of 160 microns×120 microns; a Total Transmission greater than 91% and a Diffuse Transmission less than 5%; and autocorrelation/autocovariance width between 20 microns and 300 microns.

In accordance with the teachings of the present invention, the roughness surface morphology of the scattering layer creates a diffusing effect on the ambient lighting transmitted through the cover plate of an OLED, as well as diffusely reflecting the same from the device inner surface. This eliminates the possibility of the inner surface reflections re-combining in the alternating constructive and destructive manner that creates continuous interference fringing effects. In addition, creation of this scattering layer on both surfaces of the cover plate has the added benefit of eliminating the specular reflection or glare from ambient light reflection from the outer surface of the display.

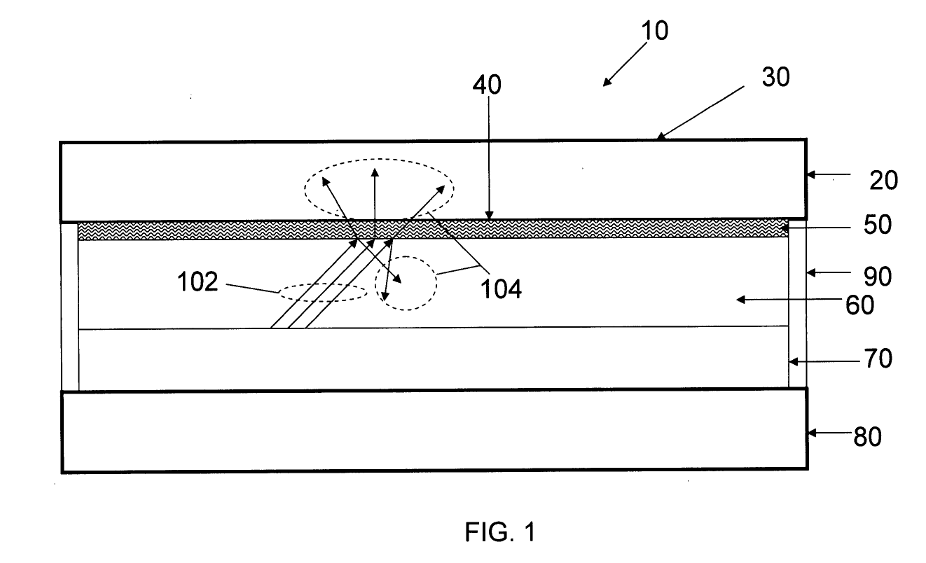

FIG. 1 displays a schematic diagram illustrating a light emitting device including a scattering layer in accordance with the teachings of the present invention. An OLED device 10 is shown. The OLED device 10 includes a cover substrate 20. The cover substrate 20 includes a topside 30 and an underside 40. A scattering layer 50 is shown contiguous with the underside 40 of the cover substrate 20. An air gap 60 is shown between the scattering layer 50 and a light emitting element 70. A support substrate 80 supports the light emitting element 70. The light emitting element 70 is shown generating incident light rays 102 that produce reflected light rays 104 when the incident light rays 102 reflect off of the topside and the underside of the cover substrate 20, the scattering layer 50, and the air gap 60. A hermetic sealant 90 is shown. The hermetic sealant may be implemented with a frit and a laser sealing process. U.S. Pat. No. 6,998,776, which is herein incorporated by reference, details a process which may be used in accordance with the teachings of the present invention.

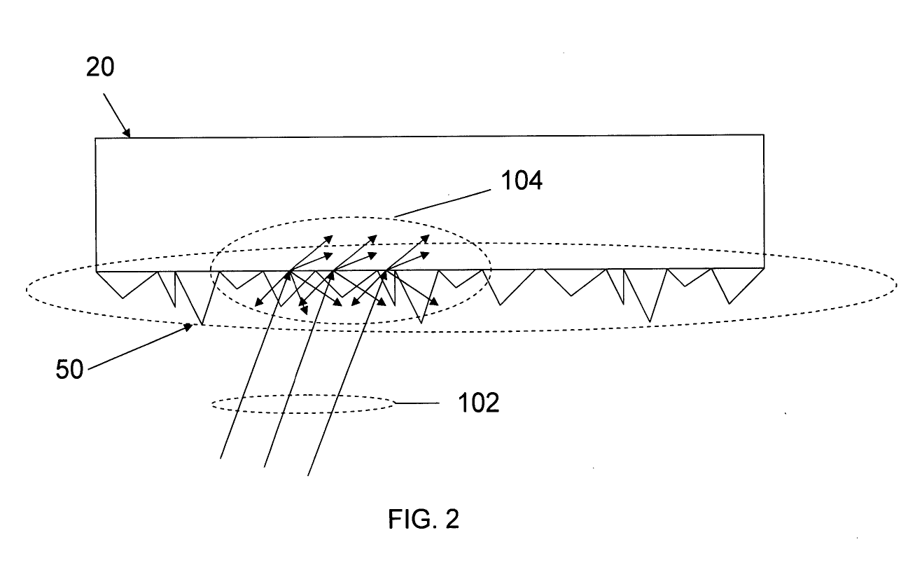

FIG. 2 is a close up of the scattering layer 50 shown in FIG. 1. In FIG. 2 the cover substrate 20 is shown contiguous with the scattering layer 50. The incident light 102 is directed toward the scattering layer 50, which then produces reflected light 104. Please note that as a result of scattering layer 50, reflected light 104 is dispersed in a variety of directions both downward into the OLED device and outward back out of the OLED device. It should be noted that there are almost no uniform deflections of the light. Conceptually, various light rays may take differing paths after reflection.

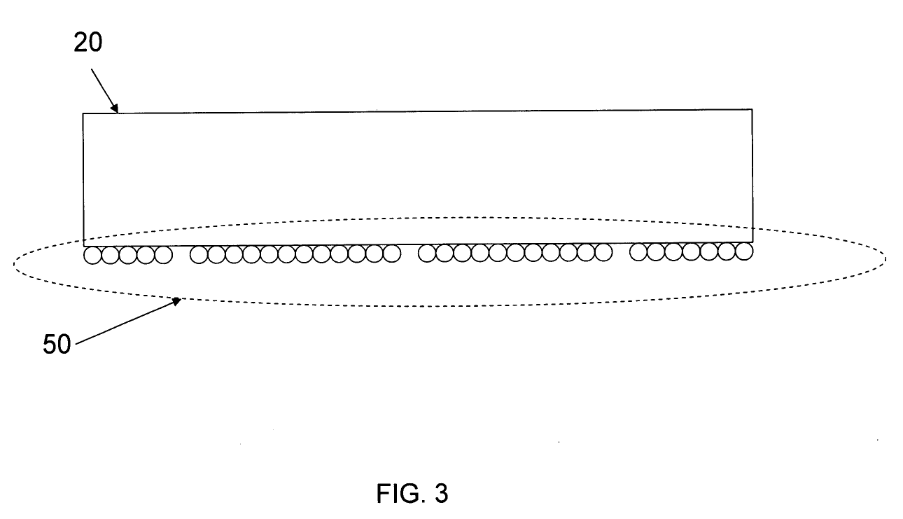

The scattering layer 50 may be implemented using a variety of methods such as by roughening the surface of the glass, by depositing transparent particles on a cover substrate, by adding a coating, etc. For example, FIG. 3 is a close up of the cover substrate 20 and the scattering layer 50 implemented with transparent particles. As shown in FIG. 3 the scattering layer 50 is implemented with transparent particles or “soot” sintered to the glass. It should be appreciated that while a variety of methods and procedures may be used to implement the scattering layer 50 any scattering layer that results in the characteristics defined in the present invention are within the scope of the present invention.

FIGS. 1, 2 and 3 all display a scattering layer 50. A scattering layer can be defined as a surface that mitigates or eliminates surface reflections from re-combining in an alternating constructive and destructive manner. The scattering layer 50 has rough surface morphology that creates a diffusing effect on incident lighting transmitted through a cover plate of an OLED, as well as diffusely reflecting the same from an inner surface of the OLED. In addition, the scattering layer 50 has the added benefit of eliminating the specular reflection or glare from ambient light reflection from the outer surface of the OLED by re-directing the light in different directions and avoiding the constructive and destructive interference patterns.

In accordance with the teachings of the present invention, the scattering layer is implemented with the following characteristics:

a roughness (RMS) greater than 0.02 microns and less than 0.5 microns, measured over an area of 160 microns×120 microns (approximately the length field of λ/4);

a total transmission greater than 91% and a diffuse transmission less than 5% (taken at 546 nm), where the total transmission is specular (i.e., complete reflection); and the diffuse transmission as-measured as diffuse+haze (haze is low angle scattering);

an autocorrelation (i.e., autocovariance) width between 20 microns and 300 microns.

The autocorrelation (i.e., autocovariance) width is the first zero crossing of a 2-dimensional autocorrelation function, where the frequency of the surface wavelengths, surface peaks and valleys or the formations on the roughened surface are high enough to avoid scattering and low enough to avoid being visible. In accordance with the teachings of the present invention the surface is characterized by surface roughness. Conceptually the surface roughness can be characterized as features on the surface that represent peaks and valleys. The peaks and valleys can vary from be implemented as sharp peaks and valleys such as you can think of with mountains or more gradual peaks and valley as you might think of with hills. In one embodiment of the present invention, the scattering layer is implemented with a roughness (RMS) greater than 0.02 microns and less than 0.5 microns, measured over an area of 160 microns×120 microns (approximately the length field of λ/4). The surface roughness is measured using a Peak-to-Valley (PV) measurement, a Roughness average (RA), and/or root mean square (RMS). The non-uniform nature of the surface (i.e., surface roughness) deflects the light in various directions and mitigates or eliminates the constructive interference. In one embodiment, the surface roughness may be non-random. A surface with surface features that stop constructive interference. In accordance with the teachings of the present invention, the roughness is measured using interferometry techniques.

The PV value is the difference between the highest and the lowest surface features. The RMS is mathematically defined as the square-root of the average of the surface deviations squared. The RMS value provides the same information as the PV but is more indicative of the overall surface quality due to the inherent averaging of the surface features. For instance, an optic that is nominally flat over the majority of the surface but has one or two extreme high and low points will tend to have a high PV and a low RMS value. The relationship between the PV and RMS values are dependent on the surface structure. The RMS is typically 4 times lower than the PV but this can vary for different surfaces.

The scattering layer implemented in accordance with the teachings of the present invention is defined with both a total transmission measure and a diffuse transmission measure. The measures of total transmission and diffuse transmission are performed using a spectrophotometer. Total transmission is the amount of the original source that makes it through a medium. In one embodiment, a total transmission greater than 91% and a diffuse transmission less than 5% (i.e., taken at 546 nm) is implemented. The total transmission is a specular measurement defining the complete reflection of light directed at the scattering layer. The diffuse transmission is measured as the diffuse transmission of light plus the haze (i.e., haze is low angle light scattering).

The transmission measurements were made from 750 nm-350 nm dual beam spectrophotometer with a 150 mm diameter integrating sphere detector. The following instrument parameters were used:

Spectral Bandwidth—3.0 nm

Scan Speed—120 nm/min

Aperture—None

Sphere Material—Spectralon

The sphere detector which was used has two ports at the back of the sphere, one for the reference beam and one for the sample beam. To perform the total transmittance measurement the ports are kept on the sphere and the sample is positioned at the sphere entry port. All forward transmitted light through the sample is collected by the sphere. For the diffuse measurement the sample port block is removed to allow the on-axis light to pass through the port into a light trap. Any off-axis light scatter (i.e., diffuse transmission) is collected by the sphere. The light trap allows some light to enter back into the sphere so a zero offset measurement is made and is subtracted from the diffuse transmittance of the sample.

In one embodiment, the scattering layer includes a morphology in which there are high points and low points (i.e., peaks and valleys). The frequency and density of these peaks and valleys may be characterized by frequency measures. In one embodiment, autocorrelation and autocovariance are used to characterize the frequency morphology of the scattering layer. In one embodiment an autocorrelation (i.e., autocovariance) width between 20 microns and 300 microns is implemented. This width is the first zero crossing of a 2-dimensional autocorrelation function. Where the frequency of formations on the roughened surface is high enough to avoid scattering and low enough to avoid being visible.

In accordance with the teachings of the present invention, a scattering layer can be implemented with the surface of the cover plate by (1) depositing small particles, by (2) mechanically roughening the surface through grit blasting (3) abrasive grinding, or (4) by chemical etching procedures. In addition, (5) polymeric optical films with an appropriate micro-texture or that contain a dispersion of fine scattering particles can be applied to the cover plate to produce the same result. In each of the embodiments, the scattering layer has an undulating morphology with characteristics as defined within this disclosure.

In one embodiment, chemical etching is used to implement the scattering layer. A variety of methods may be used to chemically etch a cover plate and create the scattering layer. In one embodiment of the present invention a fluoride based solvent was used to create the scattering layer. For example, ammonium bifluoride (NH₄F.HF) was prepared in a 150 mL per container. Two 2“×2” samples of display glass such as 1737 or Eagle 2000 both trademarks of Corning Incorporated were used. The containers included 28 wt % etchant+72 wt % H₂O. The samples were placed into the containers and then pulled out of the containers at set times. A thin film on the samples is cleaned off with H2O after the samples are removed from the container.

Table I below provides data on various samples chemically etched using ammonium biflouride:

NHRF*HF, Ammonium Bifluoride

| | Time in | | | |
|---|---|---|---|---|
| SAMPLE # | Acid (HRS) | PV (um) | RMS (um) | Ra (um) |
| 1 | 2 | 1.45 | 0.22 | 0.18 |
| 2 | 3 | 2.27 | 0.32 | 0.25 |
| 3 | 4 | 2 | 0.31 | 0.25 |
| 4 | 5 | 1.5 | 0.2 | 0.16 |
| 5 | 6 | 1.62 | 0.24 | 0.2 |
| 6 | 6 | 1.05 | 0.14 | 0.11 |

In a second example, Hydrofluoric (HF) was used as a chemical etchant. Samples sized 2“×2” were submerged in the HF for a set period of time. Solutions of HF 49% DI H2O. pH=1 were prepared. If the glass is submerged longer than 30 seconds the surface appears frosted. The layer of frost may then be rinsed off.

Table II below provides data on various samples chemically etched using Hydrofluoric:

| | Time in | PV | RMS | RA |
|---|---|---|---|---|
| Sample # | acid (min) | (microns) | (microns) | (microns) |
| 1 | 5 | 0.0437 | 0.0017 | 0.0012 |
| 2 | 10 | 0.0450 | 0.0018 | 0.0013 |
| 3 | 15 | 0.3234 | 0.0469 | 0.0365 |
| 4 | 20 | 1.0975 | 0.1817 | 0.1459 |

In accordance with the teachings of the present invention, the scattering layer may be created by depositing small particles on a substrate. In one embodiment, the small particles are implemented with fume silica particles. Fumed silica is a dense silica product made from flame hydrolysis and has nominally spherical primary particles and axial chains of secondary particles. Typically characterized by surface area per gram, and ranging in commercial products from 50 to 300 m²/g. A 300 m²/g primary particle is nominally a sphere of diameter 10 nm, but in reality exists as a chain of many particles, as many as 100 or so.

In one embodiment, fume silica dispersion is used to provide a sub-monolayer coating on a glass surface. “Peak to Valley” roughness would be modified by primary particle size at a minimum and by secondary particle size/agglomerates at a maximum. Average roughness would be modified by particle sizes as well as surface coverage, where in an ideal coating a maximum effect would be achieved at some coverage between 10 and 90%. To achieve this, a low concentration of particles is supplied in a highly wetting solvent. In one embodiment, the particles have a stronger affinity for the glass surface than for the water phase so that as the solvent evaporates the particles stick to the surface. In one embodiment, water could be used with a surfactant. Water may be preferable because acid base chemistry could be modified to provide adhesive Si(OH)₄ in solution to improve bonding of particles. Co-solvent systems might also be useful. Once the film was dried, thermal treatment to remove any surfactant, and possibly to adhere the particles to the surface by sintering would be necessary. Temperatures for the former are about 250° C., for the latter could be as high as the glass transition temperature, Tg, of the substrate glass. In addition to the dispersion of soot, colloidal silicas could be used. In accordance with the teachings of the present invention, the scattering layer can be created by mechanical roughening the substrate surface. For example, blanchard grinding, surface grinding, and grind mill techniques may be used. Blanchard grinding uses a glass sample. A circular metal plate is waxed. The heat plate is coated with wax and the substrate is adhered to the heat plate and then cooled.

The metal plate is attached to a magnet, the magnet is turned on so that the sample attaches to the blanchard table which is circular and has a larger radius than the grinding wheel. The two surfaces are parallel to each other and both spin: the grinding wheel spins in the opposite direction as the blanchard table. Coolant is sprayed onto the sample as it is being ground. The standard wheels are a coarse grind, typically 220 grit. Typically the sample has to be given a fine finish by a lapper. The grinding wheels have diamonds of different sizes embedded in them and are bonded by metal or resin. In another embodiment a surface grind may be used. With a surface grind the sample is prepared as for blanchard grinding. The metal plate is attached to a table that goes back and forth as the grinding wheel spins at 90 degrees from the table. The grinding wheel spins and lowers as the table moves laterally. Water is sprayed on the grinding wheel as it spins.

In another embodiment, lapping is performed. Lapping employs a flat circular steel or iron surface that spins horizontally onto which different loose grinding media such as ceria (CeO2) mixed with water are inserted between the wheel and the surface to be ground. In addition to different loose grinding media there are surface finishing products like non-woven nylon web impregnated with abrasive grain and resin. These products may be secured to the lapping wheel placed contiguous with a glass substrate to create a scattering layer on the glass substrate. Different types of abrasive such as bonded abrasives and coated abrasives may be used. For example, zirconia alumina may be used.

In another embodiment, polymeric optical films may be applied with an appropriate micro-texture. The scattering films may also contain a dispersion of fine scattering particles that can be applied to the cover plate to produce the same result.

A scattering layer can be applied by depositing fine particles to the surface of the cover plate. This might be accomplished by spraying a dilute suspension of lower softening point glass particles onto a substrate, or the powders may be applied by dry electrostatic spraying after which the substrate is heated above the softening point of the deposited glass to bond the particles.

Polymeric optical films with an appropriate micro-texture or that contain a dispersion of fine scattering particles can be applied to the cover substrate to affect the same result. Fine droplets of a thermal, chemical or ultraviolet setting polymers can be applied by spraying or ink jet techniques to yield the required surface roughness. Continuous films of polymer containing inorganic particles may also defeat interference fringing. These could be formed by spraying onto the substrate, or pre-formed films might be applied to the substrate.

Co-polymer films that contain multiple phases form sufficient texture to mitigate and/or cancel Newton's rings. These films also exhibit a disparity in chemical or plasma etching that would create a micro-texture similar to that created in chemical etching of glass.

In accordance with the teachings of the present invention, testing was performed to determine the limit to the characteristics of the roughened surface. Tests were performed using two different etching conditions. Newton's Rings Testing for test scenario A (i.e., Ra target=0.2 um) and test scenario B (i.e., Ra target=0.12 microns, where L refers to a lighter etch than the nominal 0.2 initial target). Two 370 micron×400 micron×0.63 micron samples created using ammonium biflouride and hydrochloric acid each were sealed to bare glass using frit sealing techniques disclosed in U.S. Pat. No. 6,998,776, which is herein incorporated by reference. The samples were visually inspected for the presence of Newton's rings using both fluorescent and green light sources.

The test A etching condition was found to eliminate the Newton's rings phenomenon, while the test B condition appeared to be the process edge (i.e., under the B conditions the Newton's rings could be seen at very shallow view angles). Samples (i.e., 370×400×0.63) were also prepared using glass-to-glass contact without a frit sealing and these OLEDS exhibited shallow Newton's rings at Ra=0.14 um but Newton's rings where not visible at Ra=0.12 um. Although extremely difficult to find very light Newton's rings were observed on the cells, which were located along one edge of one sealed sample. The Newton's rings would not have been visible if the fritted cover glass had been sealed to a live OLED back plane, which is known to contribute towards the mitigation process for Newton's rings. As such, in one embodiment, a nominal target=0.2 microns is effective for eliminating Newton's rings.

Throughout this application, various publications are referenced. The disclosures of these publications in their entireties are hereby incorporated by reference into this application in order to more fully describe the compounds, compositions, and methods described herein.

It should also be understood that while the present invention has been described in detail with respect to certain illustrative and specific aspects thereof, it should not be considered limited to such, as numerous modifications are possible without departing from the broad scope of the present invention as defined in the appended claims.

What is claimed is:

1. A light emitting device, comprising:
a cover substrate, capable of receiving light;
a support substrate;
a light emitting element positioned between the cover substrate and the support substrate; and
a first scattering layer positioned between the cover substrate and the light emitting element, the scatter layer scattering the light and mitigating Newton's rings.

2. A light emitting device as set forth in claim 1, wherein the light emitting device is a top emitting organic light emitting device.

3. A light emitting device as claimed in claim 1, wherein the first scattering layer is implemented with a roughened surface.

4. A light emitting device as claimed in claim 1, further comprising a second scattering layer contiguous with an oppositely disposed surface of the cover substrate.

5. A light emitting device as claimed in claim 1, wherein the light is generated by the light emitting element.

6. A light emitting device as claimed in claim 1, wherein the light is ambient light.

7. A light emitting device as claimed in claim 3, wherein the cover substrate includes a first surface facing the organic light emitting device and a second surface oppositely disposed from the first surface and wherein the cover substrate is roughened on the first surface and on the second surface.

8. A light emitting device as claimed in claim 1, wherein the cover substrate is glass.

9. A light emitting device as claimed in claim 1, wherein the cover substrate is plastic.

10. A light emitting device as claimed in claim 1 wherein the scattering layer comprises a roughness between about 0.02 microns and 0.5 microns over an area of 160 microns×120 microns.

11. A light emitting device as claimed in claim 1 wherein the scattering layer comprises a total transmission greater than 91% and a diffuse transmission less than 5%.

12. A light emitting device as claimed in claim 1 wherein the scattering layer comprises an autocorrelation width between 20 microns and 300 microns.

13. A light emitting device, comprising:
a cover substrate comprising a topside and a roughened underside;
a support substrate; and
an organic light emitting diode positioned between the cover substrate and the support substrate, the organic light emitting diode positioned relative to the underside of the cover substrate, wherein the roughened underside comprises a roughness between about 0.02 microns and 0.5 microns over an area of 160 microns×120 microns, the cover substrate further comprising a total transmission greater than 91% and a diffuse transmission less than 5% and an autocorrelation width between 20 microns and 300 microns.

14. A light emitting device as set forth in claim 13, wherein the organic light emitting device is a top light emitting diode emitting light through the cover substrate.

15. A light emitting device as claimed in claim 13, wherein the cover substrate is glass.

16. A light emitting device as claimed in claim 13, wherein the cover substrate is plastic.

17. A light emitting device as claimed in claim 13, wherein the cover substrate is treated with an anti-reflective coating.

18. A cellular telephone comprising the light emitting device as claimed in claim 13.

19. A television comprising the light emitting device as claimed in claim 13.

20. A method of operating a light emitting device, comprising the steps of
generating light from a light emitting element positioned within an organic light emitting device;
scattering the light with a scattering layer, the scattering layer comprising a roughness between about 0.02 microns and 0.5 microns over an area of 160 microns×120 microns, the cover substrate further comprising a total transmission greater than 91% and a diffuse transmission less than 5% and an autocorrelation width between 20 microns and 300 microns; and
mitigating Newton's rings in response to scattering the light.
